(19) United States
(12) Patent Application Publication
(10) Pub. No.: US 2017/0067507 A1
(43) Pub. Date: Mar. 9, 2017

(54) BALL-TYPE SLEEVE

(71) Applicant: Jhe-Yi JHU, New Taipei City (TW)

(72) Inventor: Jhe-Yi JHU, New Taipei City (TW)

(21) Appl. No.: 14/846,972

(22) Filed: Sep. 7, 2015

(51) Int. Cl. F16C 19/52; F16C 33/58; F16C 19/04

(52) U.S. Cl. CPC F16C 19/527; F16C 19/04; F16C 33/585

(57) ABSTRACT

A ball-type sleeve for mounting a shaft includes an inner part and an outer part in which the inner part is received. The inner part has multiple grooves defined in the outside thereof and each groove communicates with a slot which is defined through the wall of the inner part. Multiple balls are respectively located in each of the grooves and do not drop from the slot 12 corresponding to each groove. The outer part has multiple ridges extending radially from the inside thereof and the ridges are located corresponding to the slots. Each ridge has a contact face contacting the balls in the slots. A securing member secures the inner and outer parts. The ball-type sleeve reduces vibration between parts during transmission and the balls do not drop from the slots.

### BACKGROUND OF THE INVENTION

1. Fields of the invention

The present invention relates to a ball-type sleeve, and more particularly, to a ball-type sleeve having elongate slots for receiving balls therein to reduce vibration of the parts.

2. Descriptions of Related Art

When machining an object, a conventional ball-type sleeve is mounted to the shaft of the mold set to reduce friction. The conventional ball-type sleeve generally has multiple holes defined through the wall thereof and each of the holes accommodates a ball which is rotatably received in the hole. However, the balls in the holes cannot effectively reduce the negative pressure tolerance, so that the parts vibrate during transmission. The vibration reduces the work efficiency. Even worse, the balls may drop from the holes to damage the mold set.

The present invention intends to provide a ball-type sleeve to eliminate the shortcomings mentioned above.

### SUMMARY OF THE INVENTION

The present invention relates to a ball-type sleeve and comprises an inner part having a first positioning unit on the top thereof. Multiple grooves are defined in the outside of the inner part and each groove communicates with a slot which is defined through the wall of the inner part. Multiple balls are respectively located in each of the grooves and do not drop from the slot corresponding to each groove. An outer part has a second positioning unit on the top thereof. The inner part is securely located in the outer part by the engagement between the first and second positioning units. Multiple ridges extend radially from the inside of the outer part and are located corresponding to the slots. Each ridge has a contact face which contacts the balls in the slots. A securing member is connected between the bottom of the inner part and the bottom of the outer part to restrict the inner part from dropping from the outer part.

Preferably, the slots of the inner part each are an elongate slot.

Preferably, the first positioning unit has two protrusions, and the second positioning unit has two notches with which the protrusions are engaged.

Preferably, the grooves of the inner part each are an oval groove.

Preferably, the securing member is a C-clip.

Preferably, the grooves of the inner part and the ridges of the outer part each have an inclination angle of 3 to 8 degrees relative to the axis of the inner part and the outer part.

Preferably, the inclination angle is 5 degrees.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the ball-type sleeve of the present invention;

FIG. 2 is a perspective view to show the ball-type sleeve of the present invention;

FIG. 3 is a perspective view, viewed from the bottom of the ball-type sleeve of the present invention;

FIG. 4 shows the inclination angle of the grooves and the ridges of the ball-type sleeve of the present invention;

FIG. 5 is a top view of the ball-type sleeve of the present invention;

FIG. 6 is a cross sectional view, taken along line 6-6 in FIG. 5;

FIG. 7 is a cross sectional view, taken along line 7-7 in FIG. 5, and

FIG. 8 shows that the ball-type sleeve of the present invention is mounted to a shaft.

### DETAILED DESCRIPTION OF THE PREFERRED EMBODIMENT

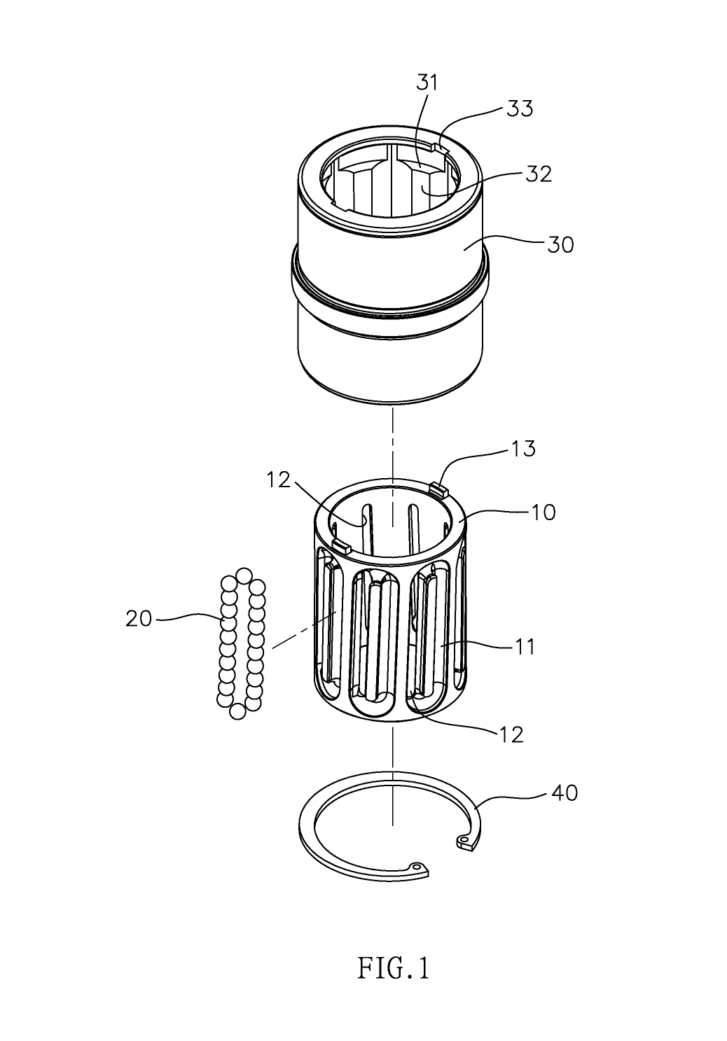

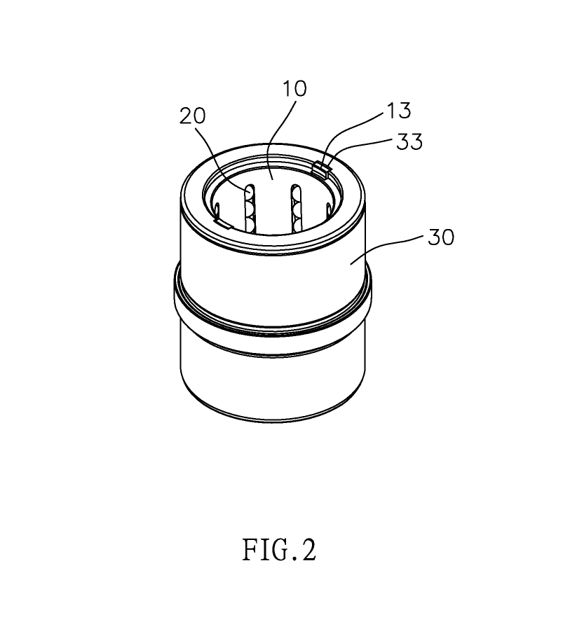

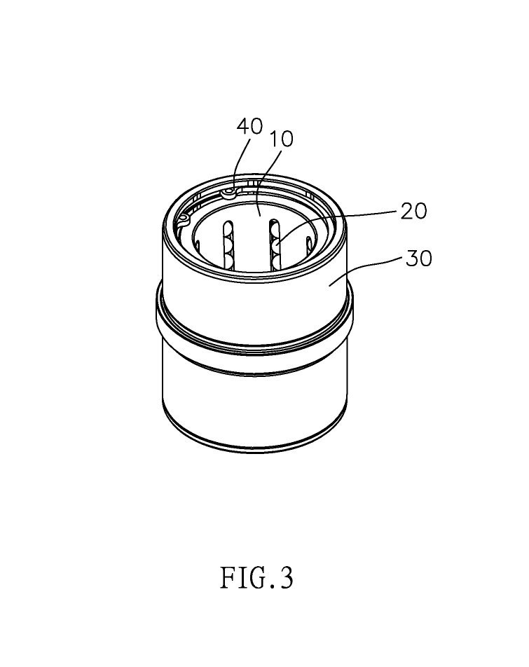

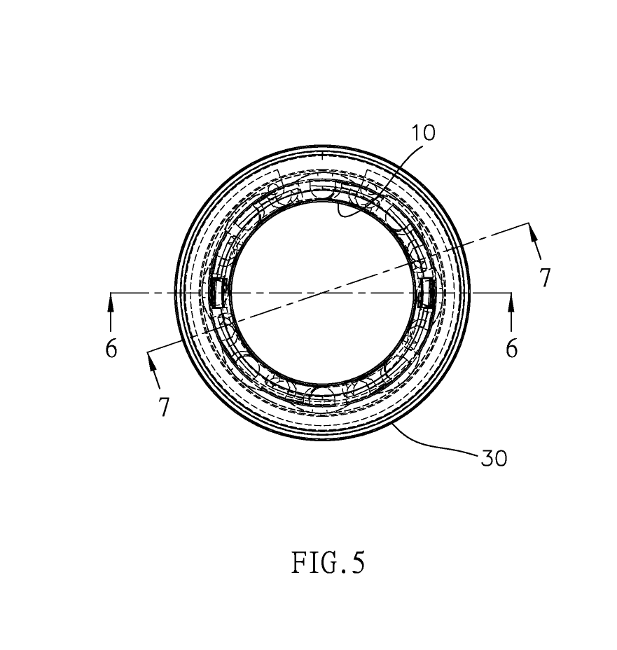

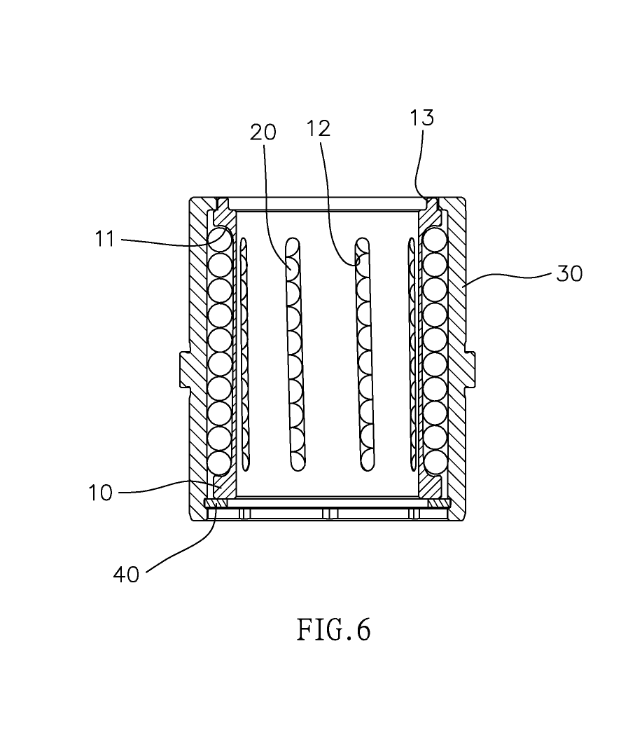

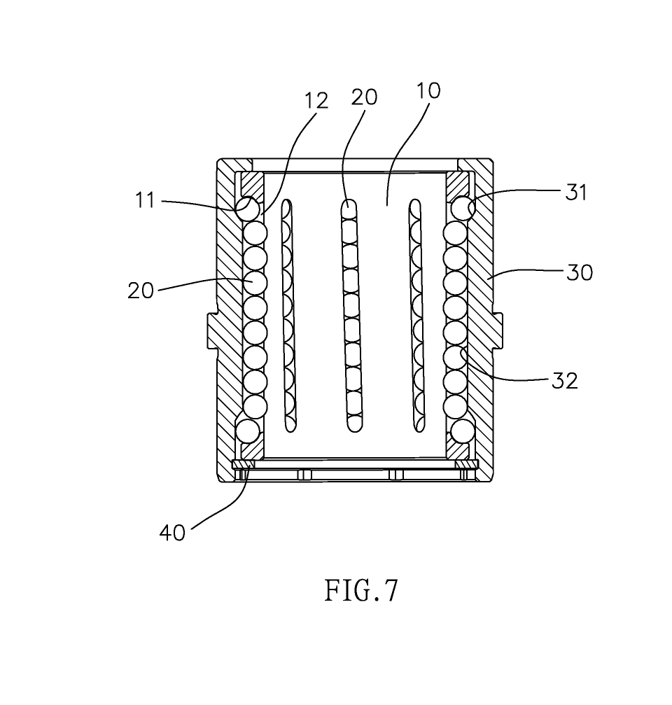

Referring to FIGS. 1 to 7, the ball-type sleeve of the present invention comprises an inner part 10, multiple balls 20, an outer part 30 and a securing member 40. The inner part 10 is a tubular part and has a first positioning unit on the top thereof. Multiple grooves 11 are defined in the outside of the inner part 10 and each groove 11 communicates with a slot 12 which is defined through the wall of the inner part 10. In this embodiment, the first positioning unit has two protrusions 13, the slots 12 of the inner part 10 each are an elongate slot, and the grooves 10 of the inner part 10 each are an oval groove. The multiple balls 20 are respectively located in each of the grooves 11 and do not drop from the slot 12 corresponding to each groove 11. The outer part 30 is a tubular part and has a second positioning unit on the top thereof. In this embodiment, the second positioning unit has two notches 33. The inner part 10 is securely located in the outer part 30 by engaging the protrusions 13 with the notches 33. Multiple ridges 31 extend radially from the inside of the outer part 30 and are located corresponding to the slots 12. Each ridge 31 has a contact face 32 which contacts the balls 20 in the slots 12. A securing member 40 is connected between the bottom of the inner part 10 and the bottom of the outer part 30 to restrict the inner part 10 from dropping from the outer part 30. In this embodiment, the securing member 40 is a C-clip.

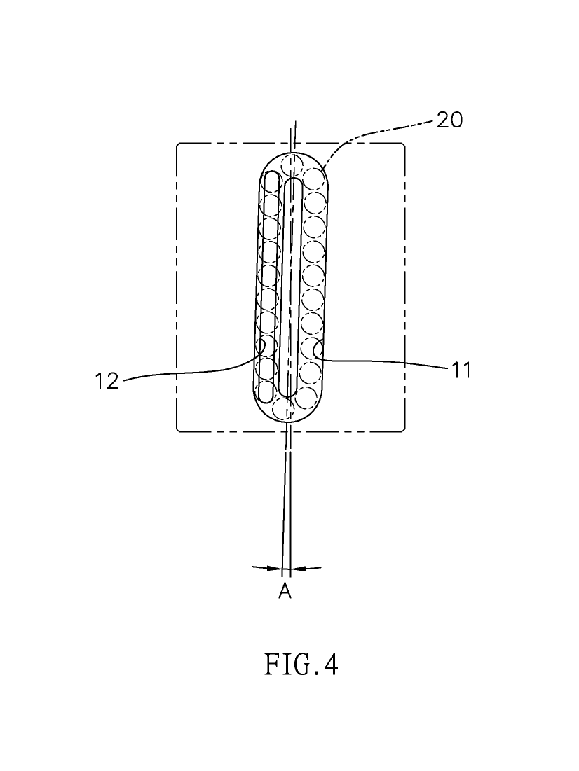

As shown in FIG. 4, the grooves 11 of the inner part 10 and the ridges 31 of the outer part 30 each have an inclination angle of 3 to 8 degrees relative to an axis of the inner part 10 and the outer part 30. Preferably, the inclination angle is 5 degrees.

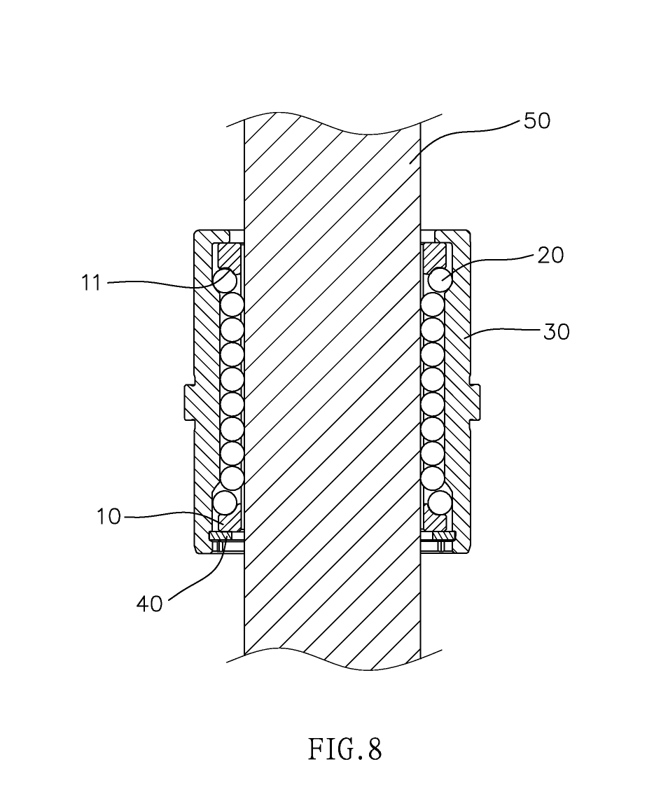

As shown in FIG. 8, when the ball-type sleeve is mounted to a shaft 50 which rotatably contacts the balls 20 so that the shaft 50 is freely rotatable. When the shaft 50 rotates, the balls 20 rotate in the grooves 11 of the inner part 10. Because there is an inclination angle “A” defined between the grooves 11 and the axis of the inner part 10, and between the ridges 31 and the axis of the outer part 30, so that the problem of the negative pressure tolerance is improved, and the vibration of the parts during transmission is reduced. The efficiency of the transmission of parts is increased. The balls 20 do not drop from the grooves 11 of the inner part 10 such that the mold set is protected from being damaged by the dropping balls, and the service life of the mold set is increased.

While we have shown and described the embodiment in accordance with the present invention, it should be clear to those skilled in the art that further embodiments may be made without departing from the scope of the present invention.

What is claimed is:

1. A ball-type sleeve comprising:
an inner part having a first positioning unit on a top thereof, multiple grooves defined in an outside of the inner part and each groove communicating with a slot which is defined through a wall of the inner part;
multiple balls respectively located in each of the grooves and being not dropping from the slot corresponding to each groove;
an outer part having a second positioning unit on a top thereof, the inner part securely located in the outer part by an engagement between the first and second positioning units, multiple ridges extending radially from an inside of the outer part and located corresponding to the slots, each ridge having a contact face which contacts the balls in the slots, and
a securing member connected between a bottom of the inner part and a bottom of the outer part to restrict the inner part from dropping from the outer part.

2. The ball-type sleeve as claimed in claim 1, wherein the slots of the inner part each are an elongate slot.

3. The ball-type sleeve as claimed in claim 1, wherein the first positioning unit has two protrusions, the second positioning unit has two notches with which the protrusions are engaged.

4. The ball-type sleeve as claimed in claim 1, wherein the grooves of the inner part each are an oval groove.

5. The ball-type sleeve as claimed in claim 1, wherein the securing member is a C-clip.

6. The ball-type sleeve as claimed in claim 1, wherein the grooves of the inner part and the ridges of the outer part each have an inclination angle of 3 to 8 degrees relative to an axis of the inner part and the outer part.

7. The ball-type sleeve as claimed in claim 6, wherein the inclination angle is 5 degrees.
